(19) United States
(12) Patent Application Publication
(10) Pub. No.: US 2005/0237607 A1
(43) Pub. Date: Oct. 27, 2005

(54) Microscope slide mask and method

(75) Inventor: Douglas A. Tenney, North Reading, MA (US)

Correspondence Address: BINGHAM, MCCUTCHEN LLP, THREE EMBARCADERO CENTER, 18 FLOOR, SAN FRANCISCO, CA, 94111-4067, US

(73) Assignee: Cytyc Corporation, Boxborough, MA (US)

(21) Appl. No.: 10/834,689

(22) Filed: Apr. 27, 2004

(51) Int. Cl. B01L 3/00; B32B 5/02; B32B 27/12; B32B 27/04; G02B 21/26; G02B 21/34

(52) U.S. Cl. 359/392; 359/396

(57) ABSTRACT

A microscope slide assembly is provided. The microscope slide assembly comprises a slide and a mask with a window that defines an examination area on the slide. Preferably, the mask further comprises a tab to facilitate removal and markings to indicate its presence. Optionally, the mask further comprises a plurality of windows that define a plurality of respective examination areas on the slide. A method for transferring cells onto a microscope slide is also provided. The method comprises transferring cells to a slide with a mask disposed thereon, removing the mask to remove unwanted cells, and recovering the removed cells from the mask.

### FIELD OF THE INVENTION

The invention pertains to devices and methods for preparing a biological material for analysis, and more particularly, to devices and methods for transferring biological material to a microscope slide.

### BACKGROUND OF THE INVENTION

Many medical tests, including pap smears, require a physician to collect cells by brushing and/or scraping a skin or mucous membrane in a target area with an instrument. The cells are then smeared onto a slide, and are fixed and transported to a laboratory where the slide is stained. The slide can then be examined under a microscope by a cytotechnologist and/or a pathologist to identify cellular abnormalities. During evaluation, a pathologist may employ a polychrome technique, characterized by staining the nuclear part of the cells, to determine the presence of dysplasia or neoplasia. The pathologist may also apply a counter-stain for viewing the cytoplasm of the cells. Because the sample may contain debris, blood, mucus, and other obscuring artifacts, the test may be difficult to evaluate, and may not provide an accurate diagnostic assessment of the collected sample.

Cytology based on the collection of the exfoliated cells into a liquid preservative offers many advantages over the traditional method of smearing the cells directly onto the slide. A slide can be prepared from the cell suspension using a filter transfer technique, as disclosed in U.S. Pat. Nos. 6,572,824, 6,318,190, 5,772,818, 5,364,597, and 5,143,627, which are expressly incorporated herein by reference.

Filter transfer methods generally start with a collection of cells suspended in a liquid. These cells may be collected and dispersed into a liquid preservative or they may naturally exist in a collected biological liquid. Dispersion in liquid preservatives containing methanol, such as PreservCyt™ solution, breaks up mucus and lyses red blood cells and inflammatory cells, without affecting the cells of interest. The liquid is then passed through a filter with a fixed diameter aperture covered by a membrane to concentrate and collect the cells. Debris, such as lysed blood cells and dispersed mucus, which flow through the pores of the membrane, are not collected on the membrane and are greatly reduced by the combined method of dispersion and filtering. Then the cells collected on the membrane are transferred onto a slide.

Filter transfer methods are capable of automation and can therefore prepare samples at a much higher rate than manual transfer methods. Existing filter transfer methods use filters with a fixed diameter aperture. Therefore cell samples spots are of a uniform size, i.e., 21 mm, even when smaller spots, i.e., 7 mm, are desired for a specific test. Filter with different size apertures can be manufactured to accommodate different desired cell spots, however, changing aperture size requires extensive recalibration of the filter transfer equipment and modification of the software controlling that equipment.

Consequently, existing filter transfer methods use filters with uniform apertures and may result in excess cells being transferred and subsequently discarded. These excess cells require the use of extra test reagents, leading to increased costs. Reducing the amount of cells lost while forming a cell sample not only reduces the amount of test reagent used, but also increases the number of tests that can be performed on cells retrieved during one sample collection procedure. This in turn allows for more confirmation testing, conserves difficult to collect cells, and reduces the number times a patient would be subjected to a collection procedure.

Accordingly, there exists a need for a device and method for forming samples of varying specific sizes using filter transfer methods. There also exists a need for a device and method for recovering cells that are unnecessarily transferred onto a slide, while forming a cell sample with the filter transfer method.

### SUMMARY OF THE INVENTION

In accordance with one aspect of the present inventions, a microscope slide assembly comprises a slide and a mask. The mask comprises at least one window, which defines an examination area on the slide. Preferably, the mask is substantially transparent and is removably disposed on the slide. The mask may have optional markings to indicate its presence and a tab that overhangs the slide for easy removal. Optionally, the mask comprises a plurality of windows that define a plurality of respective examination areas on the slide. The slide may optionally comprise a well, in which case, the window on the mask is aligned with the well to define an examination area in the well.

In accordance with another aspect of the present inventions, a microscope slide mask comprises a sheet with one dimension that substantially conforms to a dimension of a microscope slide, e.g., the width of a slide (about 1 inch). The mask has a window defining an examination area on the slide. Preferably, the mask is substantially transparent, is configured to be removably placed over the slide, and has a tab configured to overhang the slide. In the preferred embodiment, the window is circular, but may have other geometries as well. The mask may optionally comprise a plurality of windows defining a plurality of examination areas on the slide.

In accordance with still another aspect of the present invention, a method of transferring cells onto microscope slides is also provided. The cells may be any cells that would be examined using a microscope, such as cervical and bladder cells. The method comprises placing a mask on a microscope slide to define an examination area, transferring cells to the mask and slide, and removing the mask, wherein any cells disposed on the slide are contained within the examination area. In a preferred method, the sample cells are transferred to the slide by contacting the slide with sample cells collected on a filtration transfer device, which has an aperture that is larger than the window. In a preferred method, unused cells on the mask are recovered.

### BRIEF DESCRIPTION OF THE DRAWINGS

The drawings illustrate the design and utility of preferred embodiment(s) of the invention, in which similar elements are referred to by common reference numerals. In order to better appreciate the advantages and objects of the invention, reference should be made to the accompanying drawings that illustrate the preferred embodiment(s). The drawings, however, depict the embodiment(s) of the invention, and should not be taken as limiting its scope. With this caveat, the embodiment(s) of the invention will be described and explained with additional specificity and detail through the use of the accompanying drawings in which:

FIG. 1 is a perspective view of a microscope slide assembly constructed in accordance with a preferred embodiment of the present invention;

FIG. 2 is a perspective view of a slide, which comprises a part of the microscope slide assembly of FIG. 1;

FIG. 3 is a perspective view of a mask, which comprises a part of the microscope slide assembly of FIG. 1;

FIG. 4 is a perspective view of a cell transfer filter;

FIG. 5 is a perspective view of the microscope slide assembly of FIG. 1 in contact with the cell transfer filter of FIG. 4;

FIG. 6 is a perspective view of the microscope slide assembly of FIG. 1 after sample cells have been transferred thereon;

FIG. 7 is a perspective view of the microscope slide assembly of FIG. 6 showing the separation of the mask from the slide after sample cells have been transferred thereon;

FIG. 8 is a perspective view of the slide particularly showing a cell spot formed thereon by removing the mask from the slide assembly of FIG. 6;

FIG. 9 is a perspective view of the mask particularly showing a ring of unused cells formed thereon after the mask is removed from the slide assembly of FIG. 6;

FIG. 10 is a perspective view of the removed mask of FIG. 9 in a container of cell media;

FIG. 11 is a perspective view of a microscope slide assembly constructed in accordance with another preferred embodiment of the present invention;

FIG. 12 is a perspective view of a slide particularly showing three cell spots formed thereon by transferring sample cells to the slide assembly of FIG. 11 and removing the mask; and

FIG. 13 is a cross section of the microscope slide assembly of FIG. 1 along the line 13-13 in FIG. 1.

### DETAILED DESCRIPTION OF THE PREFERRED EMBODIMENTS

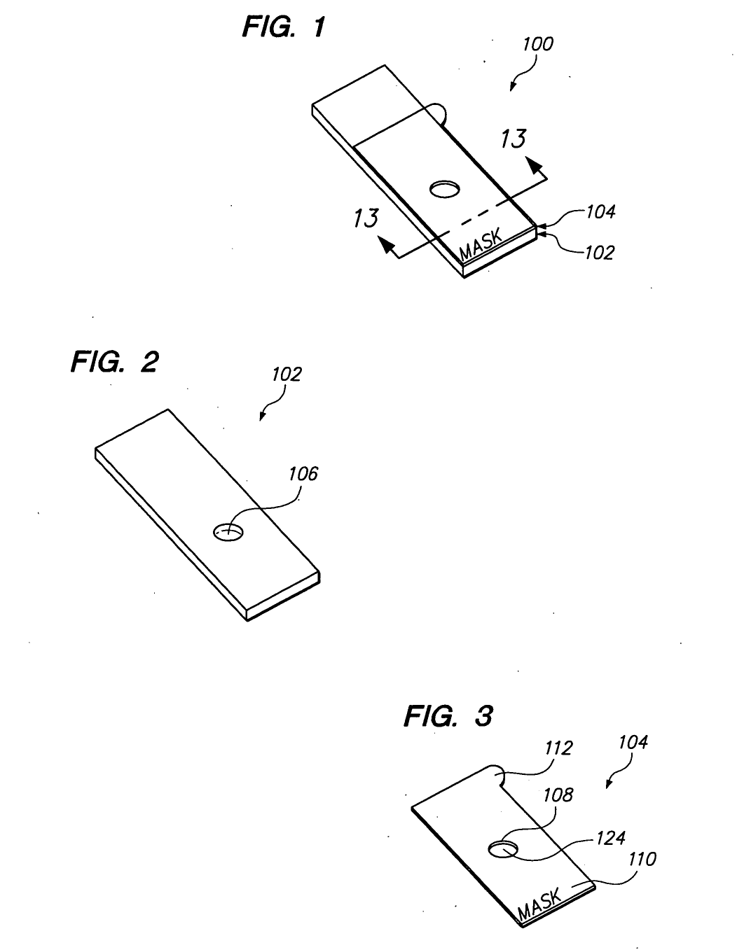

Referring to FIG. 1, a preferred embodiment of a microscope slide assembly 100 will now be described. The microscope slide assembly 100 generally comprises a slide 102 and a mask 104 removably disposed on one side of the slide 102.

The slide 102, as further shown in FIG. 2, is a standard microscope slide used in cytology and pathology, and is preferably composed of a suitable transparent material, such as glass. The dimensions of a standard slide are three inches by one inch. In this particular embodiment, the slide 102 has a well 106 formed into it using standard slide making techniques.

The mask 104, as further shown in FIG. 3, is composed of a suitable transparent material, so as not to obscure the area around the well 106 on the slide 102. The mask 104 may be cut from a roll of polymer sheeting (not shown), and then adhered to the slide 102 in a manner that allows the mask 104 to be easily removed from the slide 102 by a lab technician. The mask 104, for example, may be constructed of any solvent resistant polymer that will form sheets and adhere to glass and cells, such as polyester or polycarbonate. The resistance of the mask 104 to solvents such as methanol and ethanol allows the mask to be treated with such solvents without dissolving. The mask 104 is cut to the same width as the slide 102 and less than the length of the slide 102, so that the slide 102 can be grasped between a finger and a thumb (not shown) without grasping the mask 104.

The mask 104 comprises a window 108, (i.e., an aperture through which liquid may pass), which defines an examination area 124 that will be used to form a circular cell sample spot on the slide (see FIG. 8). In the illustrated embodiment, the window and thus the examination area are circular. In this manner the amount of reagents used to subsequently treat the cell sample spot is minimized, since reagents are applied as drops, which forms circles on slides. Although the window 108 of this preferred embodiment is circular, other window geometries, i.e., square or linear, are possible as required by the tests to be performed on the cell sample. The window 108 can be formed within the mask 104 using any suitable process. In a preferred embodiment, the window 108 is formed when the mask 104 is cut from the roll of polymer sheeting. As illustrated in FIG. 1, the window 108 is positioned, so that when the mask 104 is adhered to the slide 102, with the shorter edge of the mask 104 aligned with the shorter edge of the slide 102, the window 108 is aligned with the well 106. As a result, the window 108 defines an examination area 124 on the slide 102 coincident with the well 106. The window 108 is sized to be smaller than the aperture of the device used to transfer the cell specimen to the slide assembly 100. In the case of a filter transfer method, the window 108 will be smaller than the aperture of the filter 118. For example, if a 21 mm filter is used, the window 108 will be less than 21 mm, e.g., 10 mm, and if a 10 mm filter is used, the window 108 will be less than 10 mm, e.g., 7 mm. The mask 104 also has markings 110 printed on it that indicate the presence of the mask 104 on the slide 102.

The mask 104 can be adhered to the slide 102 before the slide is sold, using a weak adhesive 128 (see FIG. 13) or the naturally occurring electrostatic forces between the glass slide 102 and the polymer mask 104. If an adhesive 128 is used, it should be dissolvable in xylene, which is used to process the slide 102 after the mask 104 has been removed. Suitable adhesives include pressure-sensitive acrylic adhesives.

Alternatively, the mask 104 can be sold separately in a perforated roll or as pre-cut individual masks with a removable backing. With the mask 104 sold separately from the slide 102, a user can form the microscope slide assembly 100 by applying the mask 104 to the slide 102 before the cells are applied to the slide 102. Either the weak adhesive 128 or electrostatic forces will adhere the mask 104 to the slide 102.

Alternatively, rather than bonding a discrete mask onto the slide 102, the mask 104 may be silk-screened onto the slide 102. In particular, a stencil of the desired thickness in the shape of the mask 104 is aligned on the slide 102. Then a liquid polymer is applied to the stencil and the excess polymer removed. When the liquid has polymerized, the stencil can be removed and the slide 102 will have a mask 104 affixed thereon in the desired position. The window 108 can either be defined by the stencil or it can be cut from the mask 104 after it is silk-screened onto the slide 102. Markings 110 can be printed on the mask 104 after it is silk-screened onto the slide 104. In order to form the tab 112 by silk-screening, a solid substrate is used to support the polymer forming the tab 112 while it polymerizes. When the mask 104 is silk-screened onto the slide 102, the mask is held in place by electrostatic forces and not an adhesive.

Silk-screening allows for efficient mass production of microscope slide assemblies 100. For example, a die can be used to position a number of slides 104, while a stencil with the same number of masks 102 defined thereon can be placed over the slides 104. The liquid polymer can then be applied to the die in order to simultaneously form multiple masks 102 onto the respective slides 104.

In whichever manner the mask 104 is applied to the slide 102, a lab technician can remove the mask 104 from the slide 102 by grasping the slide 102 with one hand and the mask 104 with the other, and peeling the mask 104 away from the slide 102. To facilitate removal of the mask 104 from the slide 102, the mask 104 further comprises a tab 112 that is formed when the mask 104 is cut from the roll of polymer sheeting. The tab 112 is positioned along one edge of the mask 104 (in this case, along the long edge), such that when the mask 104 is mounted on top of the slide 102, the tab 112 overhangs an edge of the slide 102 (in this case, along the long edge), and may thus be grasped between a finger and a thumb (not shown). In this manner, the mask 104 can be more quickly and efficiently removed from the slide 102 when desired.

Although the slide assembly 100 has been described as having a single examination area 124, multiple examination areas can be fashioned onto a slide assembly. For example, as illustrated in FIG. 11, another preferred embodiment of a microscope slide assembly 200 is identical to the previously described assembly 100, with the exception that it comprises a slide 202 and a mask 204 with three windows 204 that define three respective examination areas 224 on the slide 202.

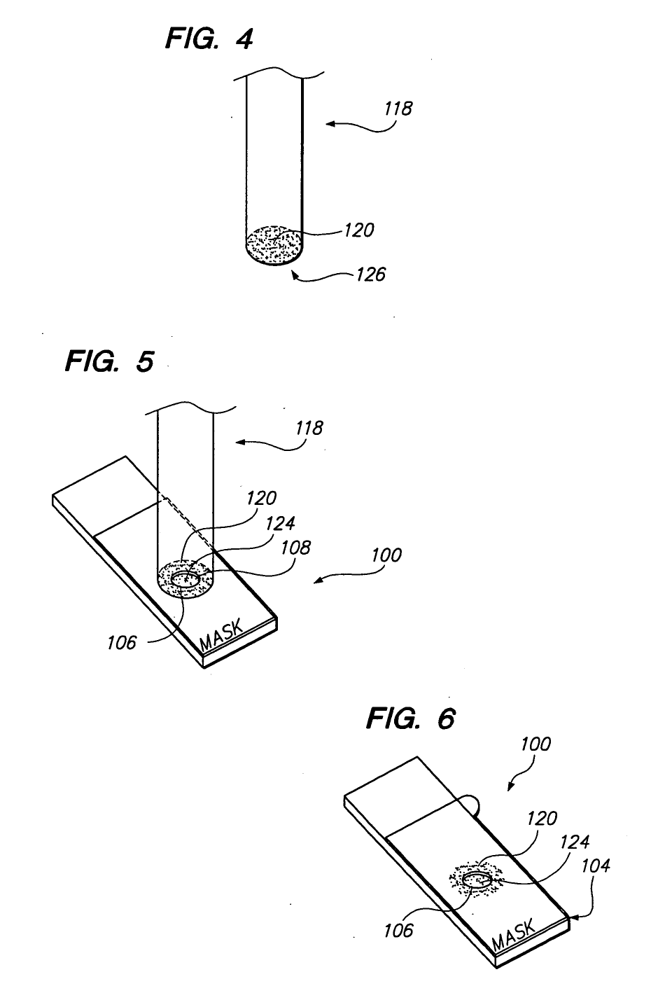

Referring to FIGS. 4 to 9, a method of using the microscope slide assembly 100 to form a cell sample spot 114 of a specified size onto the slide 102 using the filter transfer method, while recovering any unnecessarily transferred cells will now be described. In the illustrated method, a filter transfer method is used to transfer the sample cells to the microscope slide assembly, however, any method known in the medical arts, including manual transfer with a cotton swab, a tissue brush or a tissue scraper, can be used to transfer the cells.

Referring to FIG. 4, the cell transfer process begins by providing a transfer filter 118 having a membrane covered aperture 126 on which sample cells 120 are adhered. The membrane end of the transfer filter 118 is generally a tube with an open end across which is heat bonded a membrane. When a liquid containing sample cells 120 is drawn into the transfer filter 118, the sample cells 120 adhere to the outside of the membrane in the aperture 126. The sample cells 120 may be any cells that would be subjected to examination under a microscope, e.g., cervical and bladder cells. Transfer filters of all sizes can be used, including the 21 mm ThinPrep® Pap Test Filter and filters of smaller diameter, e.g., 10 mm.

As shown in FIG. 5, the sample cells 120 are transferred to the microscope slide assembly 100 by briefly touching the transfer filter 118 to the microscope slide assembly 100 at approximately the location of the window 108, which is coincident with the examination area 124 and the well 106. In the preferred method, this step is performed using automated equipment, but can be performed manually as well. The natural adhesion properties of the sample cells 120 and the electrochemical charge of the slide 102 and the mask 104 are responsible for the transfer of the sample cells 120 from the transfer filter 118 to the microscope slide assembly 100. If the ThinPrep® Pap Test Filter is used, positive air pressure behind the filter enhances transfer of the sample cells 120.

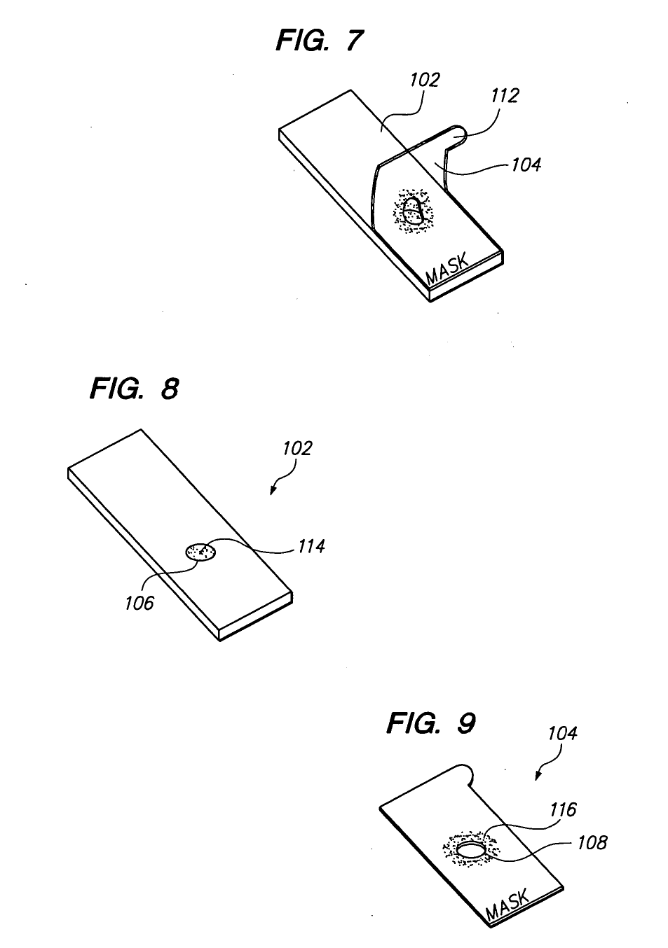

After the transfer of the sample cells 120, the microscope slide assembly 100 appears as depicted in FIG. 6. As can be seen, the sample cells 120 have not only been transferred to the examination area 124 in the well 106, but have also been transferred to the mask 104 surrounding the well 106. The mask 104 is then removed from the slide 102 by grasping the slide 102 with one hand and the tab 112 with another hand and carefully pulling the mask 104 off of the slide 102, as shown in FIG. 7. As a result, a ring of unused cells 116, which are disposed on the mask 104 around the window 106 is removed, as shown in FIG. 9, leaving a cell sample spot 114 of a specific size (the size of the window 108) on the slide 102, and specifically within the well 106, as shown in FIG. 8. Thus, any cells that are transferred to the slide 102 will be contained within the well 106.

The cell sample spot 114 can then be stained and/or fixed by techniques known in the art (not shown). Because the size of the cell sample spot 114 can be adjusted to accommodate a test by adjusting the size of the window 108 on the mask 104, less reagent will be used per test, resulting in a cost savings.

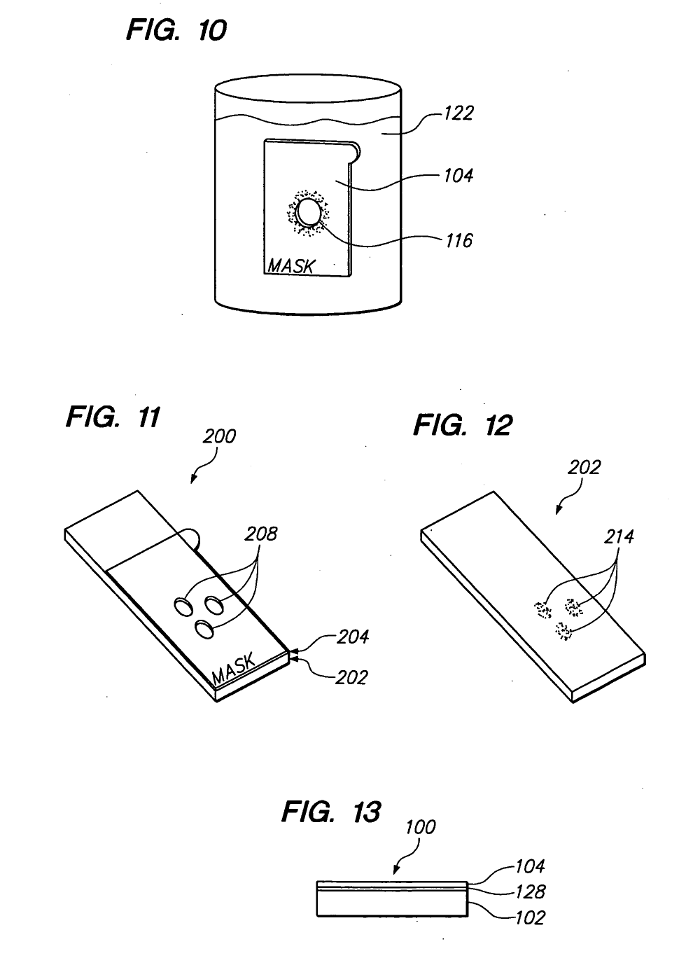

The unused cells 116 on the mask 104 are recovered by soaking the mask 104 in a container of cell media 122, as shown in FIG. 10. The cell media 122 can be any media known in the art that is compatible with the sample cells 120. For cervical cells, an example of a compatible cell media is the ethanol and methanol based PreservCyt™ solution. Agitation of the unused cells 116 on the mask 104 by briefly vortexing in the cell media 122 (not shown) or by irrigation with the cell media 122 (not shown) will facilitate transfer of the unused cells 116 from the mask 104 to the cell media 122. Once the unused cells 116 have been transferred to the cell media 122, most of the cell media 122 can be removed by centrifugation and decanting (not shown) or by filter concentration (not shown).

Alternatively, rather than using the assembly 100 to form a single sample cell spot 114, the assembly 200 illustrated in FIG. 11 can be used in a similar manner to form three cell sample spots 214 on the slide 202, as illustrated in FIG. 12. The cells sample spots 214 can then be stained and the unused cells 116 on the mask 204 recovered in the same manner described above.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

1. A microscope slide assembly, comprising:
a slide;
a mask disposed over the slide, wherein the mask has a window that defines an examination area on the slide.

2. The assembly of claim 1, wherein the mask is substantially transparent.

3. The assembly of claim 1, wherein the mask is removably disposed on the slide.

4. The assembly of claim 1, wherein the mask is adhered to the slide.

5. The assembly of claim 4, further comprising a bonding material disposed between the mask and the slide.

6. The assembly of claim 4, wherein no bonding material is disposed between the mask and the slide.

7. The assembly of claim 1, wherein the mask has a plurality of windows that define a respective plurality of examination areas on the slide.

8. The assembly of claim 1, wherein the slide comprises a well, and the mask is aligned to define the examination area in the well.

9. The assembly of claim 1, wherein the mask has a tab that overhangs the slide.

10. A microscope slide mask, comprising:
a sheet having one dimension that substantially conforms to a dimension of a microscope slide, the sheet being configured to be removably placed over the slide; and
a window defining an examination area on the slide.

11. The mask of claim 10, wherein the mask is substantially transparent.

12. The mask of claim 10, further comprising a plurality of windows defining a plurality of examination areas on the slide.

13. The mask of claim 10, wherein the window is circular.

14. The mask of claim 10, the largest dimension of the window is 20 mm is less.

15. The mask of claim 10, wherein the rectangular sheet has a tab configured to overhang the slide.

16. A method of transferring cells onto a microscope slide, comprising:
placing a mask on the slide to define an examination area on the slide;
transferring cells to the mask; and
removing the mask, wherein any cells disposed on the slide are contained within the examination area.

17. The method of claim 16, wherein the cells are transferred to the mask using a filtration transfer device.

18. The method of claim 17, wherein the filtration transfer device comprises a filter with an aperture that is larger than the window.

19. The method of claim 16, further comprising recovering a portion of the cells from the mask.
